(19) United States
(12) Patent Application Publication
(10) Pub. No.: US 2011/0305426 A1
(43) Pub. Date: Dec. 15, 2011

(54) DIGITAL VIDEO RECORDER

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/871,848

(22) Filed: Aug. 30, 2010

(30) Foreign Application Priority Data
Jun. 14, 2010 (TW) 99119234

(51) Int. Cl. H04N 5/935

(52) U.S. Cl. 386/210; 386/E05.001

(57) ABSTRACT

A digital video recorder includes a video input interface, a loop through video output interface, an A/D converter, and a multiplexer. The video input interface is electrically connected to the A/D converter. The A/D converter is configured for receiving video signals, and converting the video signals to digital signals. The loop through video output interface is connected to the video interface surface and the A/D converter through the multiplexer. The multiplexer includes a control terminal for receiving a control signal. The multiplexer is configured for connecting the video loop-through output surface to the video input surface or to the A/D converter according to the control signal.

### BACKGROUND

1. Technical Field

The present disclosure relates to a digital video recorder.

2. Description of Related Art

A digital video recorder often includes many pairs of I/O coax video interfaces. Each pair of I/O coax video interface includes an input interface connected to a video camera and a loop through video output interface configured to output the inputted video. However, the digital video recorder also includes a main video output interface. Under most conditions the main video output interface replaces the loop through video output interface to output the video to a monitor. The loop through video output interface is used to output the video to another monitor when there is a need of checking the input interface of the same pair of I/O coax video interface for defect, or playing the video on two monitors at the same time. Thus, the utilization efficiency of the loop through video output interface is low.

What is needed, therefore, is a new digital video recorder to overcome the above-described problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic view of a digital video recorder connected to two video cameras according to an exemplary embodiment.

FIG. 2 is similar to FIG. 1, but showing the digital video recorder is connected to a video camera and a monitor.

### DETAILED DESCRIPTION

Embodiments of the present disclosure will now be described in detail below, with reference to the accompanying drawings.

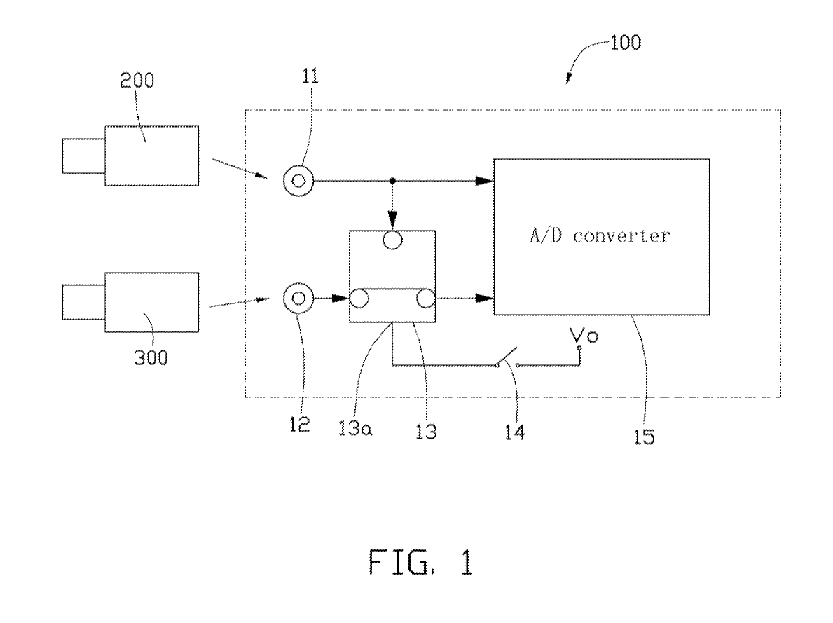

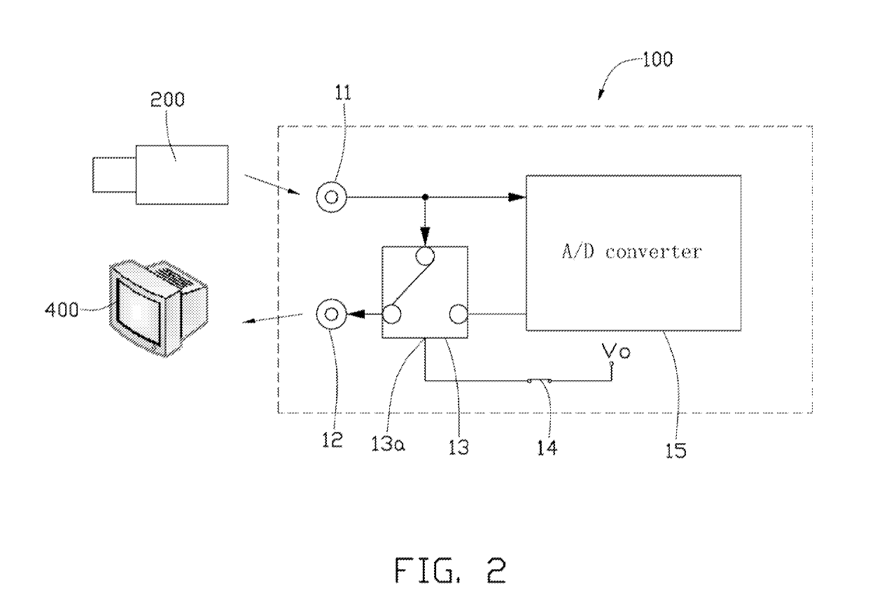

Referring to FIGS. 1 and 2, a digital video recorder 100 according to an exemplary embodiment is shown. The digital video recorder 100 includes a video input interface 11, a loop through video output interface 12, a multiplexer 13, a switch 14, and an A/D converter 15. In other embodiments, the number of the video input interface 11, the corresponding loop through video output interface 12, the corresponding multiplexer 13, the corresponding switch 14, and the corresponding A/D converter 15 can also be four, eight, or sixteen. The other elements of the digital video recorder 100 are omitted.

The video input interface 11 is a coax interface. The video input interface 11 is configured for connecting to a first video camera 200. The video input interface 11 is electrically connected to the multiplexer 13 and the A/D converter 15, and transmits the video data from the first video camera 200 to the multiplexer 13 and the A/D converter 15.

The multiplexer 13 is connected to the loop through video output interface 12 and the A/D converter 15. The multiplexer 13 is a 2 in 1 multiplexer. The multiplexer 13 is configured for connecting the loop through video output interface 12 to the video input interface 11 or to the A/D converter 15. The multiplexer 13 includes a controlling terminal 13a for receiving a control signal, and controls the multiplexer 13 shifts between the two connection states according to the control signal. The controlling terminal 13a can be controlled manually or by a programmed controller (not shown) installed in the digital video recorder 100. In the present embodiment, the controlling terminal 13a is connected to the switch 14. The switch 14 is connected to a high electric potential Vo. The multiplexer 13 is controlled by manually opening or closing the switch 14. When the switch 14 is opened, the multiplexer 13 is electrically connected between the loop through video output interface 12 and the A/D converter 15. When the switch 14 is closed, the multiplexer 13 is electrically connected between the loop through video output interface 12 and the video input interface 11. In other embodiments, the operation of the multiplexer 13 can be operated in reverse. Because the loop through video output interface 12 is rarely used as an output interface, the switch 14 is a normally open switch.

The loop through video output interface 12 is a coax interface and used for connecting to a second video camera 300 or a monitor 400. When the loop through video output interface 12 needs to be connected the second video camera 300, the switch 14 is opened, and the multiplexer 13 is electrically connected between the loop through video output interface 12 and the A/D converter 15. The second video camera 300 outputs video data to the A/D converter 15 through the loop through video output interface 12. Thus, the digital video recorder 100 can connect 2 video cameras at the same time. The capability of the loop through video output interface 12 is extended.

When the loop through video output interface 12 needs to be connected to the monitor 400, the switch 14 is closed to connect the controlling terminal 13a to the high electric potential Vo, and the multiplexer 13 is electrically connected the loop through video output interface 12 to the video input interface 11. The video input interface 11 outputs video data to the monitor 400 through the loop through video output interface 12. Thus, the original functions of the loop through video output interface 12 still exits.

The A/D converter 15 is configured for receiving video signal, and converting the video signal to digital signal for the following signal processing device (not show).

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A digital video recorder comprising:
a video input interface;
a loop through video output interface;
an A/D converter electrically connected to the video input interface, and configured for receiving a video signal and converting the video signal into a digital signal; and
a multiplexer connecting between the loop through video output interface and the A/D converter and connecting to a node between the video input interface and the A/D converter, the multiplexer comprising a controlling terminal configured for controlling the multiplexer to connect the loop through video output interface to the video input interface or to connect the loop through video output interface to the A/D converter according to a receiving control signal.

2. The digital video recorder as claimed in claim 1, wherein the loop through video output interface is a coax interface.

3. The digital video recorder as claimed in claim 1, wherein the video input interface is a coax interface.

4. The digital video recorder as claimed in claim 1, wherein the multiplexer is a 2 in 1 multiplexer.

5. The digital video recorder as claimed in claim 1, further comprising a switch, wherein one end of the switch is connected to a high potential, the other end of the switch is connected to the controlling terminal, the multiplexer connects the loop through video output interface to the video input interface or to the A/D converter according to the connection state of the switch.

6. The digital video recorder as claimed in claim 5, wherein the switch is a normally open switch.

7. The digital video recorder as claimed in claim 6, wherein when the switch is opened, the multiplexer is electrically connected between the loop through video output interface and the A/D converter, otherwise the multiplexer is electrically connected between the loop through video output interface and the video input interface.

8. A digital video recorder comprising:
a video input interface;
an A/D converter electrically connected to the video input interface, and configured for receiving video signals, and converting the video signals to digital signals;
a loop through video output interface connected to the video input interface and the A/D converter through a multiplexer, wherein the multiplexer comprises a controlling terminal configured for controlling the multiplexer to connect the loop through video output interface to the video input interface or to connect the loop through video output interface to the A/D converter.

9. The digital video recorder as claimed in claim 8, wherein the loop through video output interface is a coax interface.

10. The digital video recorder as claimed in claim 8, wherein the video input interface is a coax interface.

11. The digital video recorder as claimed in claim 8, wherein the multiplexer is a 2 in 1 multiplexer.

12. The digital video recorder as claimed in claim 8, further comprising a switch, wherein one end of the switch is connected to a high potential, the other end of the switch is connected to the controlling terminal, the multiplexer connects the loop through video output interface to the video input interface or to the A/D converter according to the connection state of the switch.

13. The digital video recorder as claimed in claim 12, wherein the switch is a normally open switch.

14. The digital video recorder as claimed in claim 13, wherein when the switch is opened, the multiplexer is electrically connected between the loop through video output interface and the A/D converter, otherwise the multiplexer is electrically connected between the loop through video output interface and the video input interface.
